(19) United States
(12) Patent Application Publication
(10) Pub. No.: US 2005/0090613 A1
(43) Pub. Date: Apr. 28, 2005

(54) Process for preparing fluorine-containing polymer latex

(75) Inventors: Yoshiki Maruya, Osaka (JP); Michio Asano, Osaka (JP); Shunji Kasai, Osaka (JP); Kenji Ichikawa, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD.

(21) Appl. No.: 10/689,732

(22) Filed: Oct. 22, 2003

(51) Int. Cl. C08K 3/00

(52) U.S. Cl. 524/805

(57) ABSTRACT

There is provided a fluorine-containing polymer latex providing a fluorine-containing polymer material being excellent in mechanical properties of a molded article. The preparation process comprises emulsion-polymerizing a fluorine-containing olefin solely or a fluorine-containing olefin and other monomer in an aqueous medium in the presence of at least one of fluorine-containing surfactants represented by the formula (I):
F(CF₂ₘO—(CF(X)CF₂—OₙCF(X)COOM wherein X is fluorine atom or a linear or branched lower perfluoroalkyl group; —COOM is a carboxylic acid salt; m is an integer of from 3 to 10; n is 0, 1 or 2. There are also provided a molding material and dispersion comprising a tetrafluoroethylene/hexafluoropropylene copolymer, polytetrafluoroethylene or fluoro elastomer which are obtained by the above-mentioned preparation process.

### BACKGROUND OF THE INVENTION

The present invention relates to a process for preparing a fluorine-containing polymer latex which comprises emulsion-polymerizing a fluorine-containing olefin in an aqueous medium in the presence of a specific fluorine-containing surfactant.

When preparing a fluorine-containing polymer latex by emulsion-polymerizing a fluorine-containing olefin as a monomer in an aqueous dispersion, it is essential that a surfactant (emulsifying agent) is present in a polymerization system, and various surfactants have been proposed and used.

It is known that those surfactants have an adverse effect on various characteristics of an obtained fluorine-containing polymer, for example, characteristics of a powder and mechanical properties of a molded article (JP52-52984A, JP57-164199A, JP11-246607A, JP11-512133A, etc.).

An object of the present invention is to provide a process for preparing a fluorine-containing polymer latex by emulsion-polymerizing a fluorine-containing olefin by using a specific fluorine-containing surfactant, thereby providing a fluorine-containing polymer material being excellent in mechanical properties of a molded article.

### SUMMARY OF THE INVENTION

Namely, the present invention relates to a process for preparing a fluorine-containing polymer latex which comprises emulsion-polymerizing a fluorine-containing olefin solely or a fluorine-containing olefin and other monomer in an aqueous medium in the presence of at least one of fluorine-containing surfactants represented by the formula (I):
F(CF₂ₘO—(CF(X)CF₂—OₙCF(X)COOM
wherein X is fluorine atom or a linear or branched lower perfluoroalkyl group; —COOM is a carboxylic acid salt; m is an integer of from 3 to 10; n is 0, 1 or 2.

Examples of the preferred carboxylic acid salt represented by —COOM are an alkali metal salt, ammonium salt and lower alkylamine salt.

The fluorine-containing olefin used for the emulsion polymerization are tetrafluoroethylene (TFE), hexafluoropropylene (HFP) and/or perfluoro(alkyl vinyl ether) (PAVE), which are suitable for producing a latex of TFE copolymer (hereinafter “FEP” is typically referred to as TFE copolymer).

FEP has heat resistance, chemical resistance and electrical properties equal to those of polytetrafluoroethylene (hereinafter referred to as “PTFE”) which is a homopolymer of TFE, and has melt flowability which cannot be recognized in PTFE. Therefore FEP can be processed by melt-processing method such as compression molding, extrusion molding, injection molding, fluid bed molding and the like and has been used in various applications.

Example of other preferred fluorine-containing olefin is TFE, and the preparation process of the present invention is also suitable for preparation of PTFE latex which is a homopolymer of TFE.

In the present invention, PTFE encompasses not only a TFE homopolymer but also a modified PTFE prepared by copolymerizing other comonomer in a small amount not imparting melt-flowability. Examples of such a comonomer are hexafluoropropylene (HFP), chlorotrifluoroethylene, perfluoro(alkyl vinyl ether) (PAVE), perfluoro(alkoxy vinyl ether), trifluoroethylene, perfluoroalkylethylene and the like. A proportion of copolymerizing comonomers varies depending on kind of comonomers. For example, when perfluoro(alkyl vinyl ether) or perfluoro(alkoxy vinyl ether) is used as a comonomer, an amount thereof is usually up to 2% by weight, preferably from 0.01 to 1% by weight.

It is preferable that in the case of FEP, the above-mentioned fluorine-containing surfactant is added in an amount of from 0.001 to 5.0% by weight, preferably from 0.01 to 2.0% by weight based on an aqueous medium at initiating the polymerization. In the case of polymerizing PTFE, it is preferable that the surfactant is added in an amount of from 0.001 to 0.5% by weight, preferably from 0.01 to 0.3% by weight based on an aqueous medium at initiating the polymerization.

### DETAILED DESCRIPTION

The present invention is characterized by use of the specific fluorine-containing surfactant represented by the above-mentioned formula (I).

In the present invention, non-limiting examples of the particularly preferred fluorine-containing surfactant are those mentioned below:
F(CF₂₇O—CF(CF₃)COOM,
F(CF₂₅O—CF(CF₃)COOM,
F(CF₂₃O—CF(CF₃)COOM and
F(CF₂₅O—(CF(CF₃)CF₂O)C(CF₃)COOM,
wherein M is an alkali metal, ammonium ion or lower alkylamine constituting sulfonic acid salt.

The fluorine-containing olefin which is a monomer polymerized in the preparation process of the present invention is a monomer represented by the formula (1): 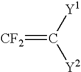
wherein Y¹ is F, Cl, H or CF₃; Y² is F, Cl, H, Rf³, in which Rf³ is a perfluoroalkyl group having 1 to 10 carbon atoms, or 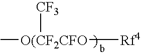
wherein Rf⁴ is a perfluoroalkyl group having 1 to 6 carbon atoms, b is 0 or an integer of from 1 to 5, or
a monomer represented by the formula (2): 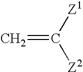
   wherein Z¹ is F, H, an alkyl group having 1 to 6 carbon atoms or a perfluoroalkyl group having 1 to 10 carbon atoms; Z² is H, Cl, an alkyl group having 1 to 6 carbon atoms or —(CF₂)_{d}-Z³, in which d is an integer of from 1 to 10, Z³ is F or H. At least one of those monomers is subjected to polymerization.

Examples of preferred monomer of the formula (1) are: 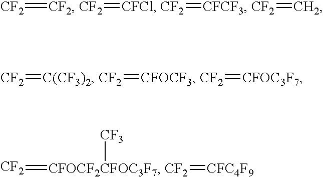
and the like.

Examples of preferred monomer of the formula (2) are, for instance, CH₂═CHF, CH₂═CFCF₃, CH₂═CHCF₃, CH₂═C(CF₃)₂, CH₂═CHC₄F₉, CH₂═CF(CF₂)₃—H and the like.

In the present invention, those fluorine-containing olefins can be polymerized solely or copolymerized with each other or copolymerized with an ethylenic unsaturated non-fluorine-containing monomer.

Examples of the ethylenic unsaturated non-fluorine-containing monomer are, for instance, alkyl vinyl ethers or vinyl esters represented by the formula:
CH₂═CH—O—(C═O)_{e″}R⁸
wherein R⁸ is an aliphatic group having 1 to 17 carbon atoms, an alicyclic group having 3 to 17 carbon atoms or a fluoroalkyl group having 1 to 20 carbon atoms, e″ is 0 or 1. Examples thereof are, for instance, methyl vinyl ether, ethyl vinyl ether, n-propyl vinyl ether, isopropyl vinyl ether, n-butyl vinyl ether, isobutyl vinyl ether, cyclohexyl vinyl ether, 2,2,2-trifluoroethyl vinyl ether, 2,2,3,3-tetrafluoropropyl vinyl ether, 2,2,3,3,3-pentafluoropropyl vinyl ether, vinyl acetate, vinyl propionate, vinyl butyrate, vinyl pivarate, vinyl versatate, vinyl cyclohexane carboxylate and the like.

Further there are compounds represented by the formula: 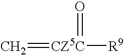
wherein Z⁵ is H, Cl, F, CH₃ or CF₃; R⁹ is H, Cl, F, an aliphatic group having 1 to 17 carbon atoms, an alicyclic group having 3 to 17 carbon atoms or a fluoroalkyl group having 1 to 20 carbon atoms. Examples thereof are, for instance, isobutyl acrylate, methyl acrylate, ethyl methacrylate, 2,2,3,3,3-pentafluoropropyl-α-fluoroacrylate, 2,2,3,3,4,4,5,5,6,6,7,7-dodecafluoropentyl-α-trifluoromethylacrylate, cyclohexyl acrylate, 2,2,3,3,4,4,5,5,6,6,7,7,8,8,9,9,10,10,11,11,12,12,13,13,14,14,15,15,15-nonacosafluoropentadecylacrylate, octyl-α-chloroacrylate, octadecylacrylate and the like.

Also there can be used compounds represented by the formula:
CH₂═CHCH₂Z⁶
wherein Z⁶ is chlorine atom or an alkoxy group having 1 to 8 carbon atoms. Examples thereof are, for instance, allyl chloride, allyl methyl ether, allyl isopropyl ether, allyl octyl ether and the like.

In addition, there are styrene, styrene derivatives, dialkyl maleates and the like.

Also there can be copolymerized fluorine-containing or non-fluorine-containing monomers having functional group described in WO95/33782 such as hydroxyl, carboxyl, carboxylic acid ester, epoxy, thiol or the like.

The preferred structure of the fluorine-containing polymer obtained in the present invention is roughly classified into two groups. One is a structure mainly comprising tetrafluoroethylene (TFE) or chlorotrifluoroethylene (CTFE) as a fluorine-containing olefin, and another one is a structure mainly comprising vinylidene fluoride (VdF), Namely, the first group is a fluorine-containing polymer comprising TFE or CTFE as an essential component and obtained by copolymerizing other copolymerizable monomer as case demands.

In the above-mentioned polymer, examples of particularly preferred other copolymerizable monomer are VdF, HFP, hexafluoroisobutene, perfluorovinylethers (PAVE) represented by the formula: 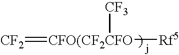
wherein Rf⁵ is a perfluoroalkyl group having 1 to 6 carbon atoms; j is 0 or an integer of from 1 to 5, fluorine-containing olefins represented by the formula: 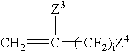
wherein Z³ is H or F; Z⁴ is H or F; i is an integer of from 1 to 10, ethylene, propylene, 1-butene, isobutene and the like. Particularly HFP and PAVE are preferred.

Further examples of the fluorine-containing polymer mainly comprising TFE or CTFE are TFE homopolymer (PTFE), a copolymer (FEP) of TFE, HFP and as case demands, a small amount of PAVE, a copolymer (PFA) of TFE and PAVE (not more than 10% by mole), a copolymer (E(C)TFE) of TFE or CTFE, ethylene and as case demands, a copolymerizable fluorine-containing olefin, an elastomeric copolymer prepared by copolymerizing TFE with propylene, an elastomeric copolymer prepared by copolymerizing TFE with perfluorovinylethers (not less than 15% by mole) and the like.

Among the PFA copolymers, preferred is a copolymer comprising 95 to 99.7% by mole of TFE and from 0.3 to 5.0% by mole of perfluorovinylether represented by the formula:
CF₂═CFORf¹²
wherein Rf¹² is a perfluoroalkyl group having 1 to 6 carbon atoms.

Also preferred FEP is a copolymer comprising 89.5 to 96.7% by mole of TFE, 3.3 to 10.5% by mole of HFP and 0 to 2.0% by mole of PAVE.

A preferred process for preparing FEP latex is a seed polymerization process in which first, seed particles of FEP having a small particle size are prepared and then emulsion polymerization is carried out in an aqueous polymerization medium containing seed particles dispersed therein, aiming at the above-mentioned composition of FEP. A merit of the seed polymerization is that since the number of particles being present in the final product, namely FEP latex can be determined by a particle size of seed particles and a weight percent of the latex, the particle size in the latex can be controlled in preparing FEP.

Also a preferred E(C)TFE copolymer is a copolymer comprising 30 to 70% by mole of TFE or CTFE, 30 to 70% by mole of ethylene and 0 to 15% by mole of fluorine-containing olefin as the third component. Examples of the fluorine-containing olefin as the third component are fluorine-containing olefins represented by the formula: 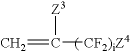
wherein Z³ is H or F; Z⁴ is H or F; i is an integer of from 1 to 10, perfluorovinylethers, HFP, hexafluoroisobutylene and the like. Particularly preferred are: 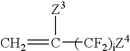
wherein Z³, Z⁴ and i are as defined above, and hexafluoroisobutylene.

One of the elastomeric copolymers mainly comprising TFE is a copolymer comprising 40 to 70% by mole of TFE and 30 to 60% by mole of propylene. In addition, other copolymerizable component, for example, VdF, HFP, CTFE, perfluorovinylethers or the like can be contained in an amount of not more than 20% by mole.

Another elastomeric polymer is a polymer comprising TFE and perfluorovinylethers, which is a polymer comprising 40 to 85% by mole of TFE and 15 to 60% by mole of perfluorovinylethers represented by the formula: 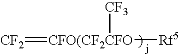
wherein Rf⁵ is a perfluoroalkyl group having 1 to 6 carbon atoms; j is 0 or an integer of from 1 to 5.

The preferred fluorine-containing polymers of the second group which are prepared by the preparation process of the present invention are polymers mainly comprising VdF.

Namely, the fluorine-containing polymers are copolymers comprising VdF as an essential component and obtained by further copolymerizing other monomer as case demands. Those polymers contain not less than 40% by mole of VdF.

Examples of other preferred copolymerizable monomer in the VdF polymer are TFE, CTFE, HFP, hexafluoroisobutylene and perfluorovinylethers.

Examples of the preferred fluorine-containing polymer mainly comprising VdF are VdF homopolymer (PVdF), VdF/TFE copolymer, VdF/HFP copolymer, VdF/TFE/HFP copolymer, VdF/TFE/CTFE copolymer and the like.

Those fluorine-containing polymers mainly comprising VdF can be formed into resinous or elastomeric polymers by selecting kind and amount of other monomer component to be copolymerized or by determining whether or not other monomer component is used.

Among them, examples of the preferred resinous VdF polymer are VdF/TFE (50 to 99/1 to 50% by mole ratio) copolymer, VdF/TFE/HFP (45 to 99/0 to 45/1 to 10% by mole ratio) copolymer, VdF/TFE/CTFE (50 to 99/0 to 30/1 to 20% by mole ratio) copolymer and the like.

Also example of the preferred elastomeric VdF copolymer is one comprising 40 to 90% by mole of VdF, 0 to 30% by mole of TFE and 10 to 50% by mole of HFP.

Further the fluorine-containing polymer encompasses a fluorine-containing segmented polymer disclosed in JP61-49327B.

This fluorine-containing segmented polymer basically comprises, as essential components, iodine atom released from an iodide compound having iodine atom bonded to carbon atom, a residue remaining after releasing the iodine atom from the iodide compound and at least two polymer chain segments being present between the iodine atom and the residue (at least one of them is a fluorine-containing polymer chain segment). In other words, the fluorine-containing segmented polymer basically comprises, as essential components, a continuation chain comprising at least two polymer chain segments (at least one of them is a fluorine-containing polymer chain segment), iodine atoms released from iodide compounds which are present at both ends of the connected chain and have iodine atom bonded to carbon atom and a residue remaining after releasing the iodine atom from the iodide compound. Namely a typical structure of the fluorine-containing segmented polymer can be represented by the following formula:
Q-[(A-B—- - - )I]f″
wherein Q is a residue remaining after releasing the iodine atom from the iodide compound; A-B—- - - represent the respective polymer chain segments (at least one of them is a fluorine-containing polymer chain segment); I is iodine atom released from the iodide compound, f″ represents the number of bonds of Q.

A suitable range of molecular weight of the fluorine-containing polymer obtained in the present invention varies depending on kind, application and use of the polymer and is not limited particularly. For example, for molding applications, generally a too low molecular weight is not preferred from the viewpoint of mechanical strength of the fluorine-containing polymer. A number average molecular weight is usually not less than 2,000, particularly preferably not less than 5,000. Also from the viewpoint of moldability, a too high molecular weight is not preferable, and a molecular weight is usually not more than 1,000,000, particularly preferably not more than 750,000.

Further among the examples of fluorine-containing polymer, in the case of the above-mentioned resinous copolymers mainly comprising TFE, for example, melt-processable fluorine-containing polymer such as PFA, FEP and ETFE, a melt flow rate thereof is 0.01×10⁻² to 50×10⁻² ml/sec, preferably 0.05×10⁻² to 25×10⁻² ml/sec, particularly preferably 0.1×10⁻² to 10×10⁻² ml/sec at a given temperature (for example, 372° C. in PFA and FEP and 300° C. in ETFE) at a given load (for example, 7 kg) depending on kind of the fluorine-containing polymer.

Also in the case of fluorine-containing polymers being soluble in a solvent such as DMF and THF which are elastomeric polymers mainly comprising TFE, VdF homopolymer and resinous or elastomeric polymers mainly comprising at least one of VdF, TFE, HFP and CTFE, a number average molecular weight measured based on polystyrene with GPC is from 2,000 to 1,000,000, preferably from 5,000 to 750,000, particularly preferably from 10,000 to 500,000.

Also the TFE homopolymer (PTFE) encompasses polymers in the form of oligomer, polymers generally called low molecular weight PTFE having a molecular weight of about 2,000 to about 1,000,000 and further high molecular weight polymers which cannot be melt-processed. A molecular weight of the high molecular weight PTFE cannot be specified, but those having a molecular weight of from about 1,000,000 to about 10,000,000, at most about 20,000,000 can be prepared.

The fluorine-containing polymer latex of the present invention is prepared by emulsion polymerization.

For the emulsion polymerization, usually a radical initiator can be used as a polymerization initiator, and a water soluble initiator is used preferably. Examples thereof are inorganic initiators, for instance, persulfates such as ammonium persulfate, hydrogen peroxides, redox initiator obtained therefrom in combination of a reducing agent such as sodium hydrogen sulfite or sodium thiosulfate, initiators obtained therefrom by mixing a small amount of iron, ferrous salt, silver nitrate or the like; or organic initiators, for instance, dibasic acid peroxides such as disuccinic acid peroxide and diglutaric acid peroxide, azobisisobutylamidine dihydrochloride; and the like. Also known oil soluble initiators can be used.

The present invention is characterized in that the above-mentioned fluorine-containing surfactant of the formula (I) is used as a surfactant for the emulsion polymerization. A total adding amount thereof is from 0.001 to 20% by weight, preferably from 0.01 to 10% by weight based on the polymerization medium (aqueous medium).

Also as case demands, a hydrocarbon type anionic, cationic, nonionic or bataine surfactant can be used together.

Further if necessary, known chain transfer agent, pH buffer agent, pH regulator and the like can be used.

As the chain transfer agent, there can be used, for example, isopentane, n-hexane, cyclohexane, methanol, ethanol, tert-butanol, carbon tetrachloride, chloroform, methylene chloride, methyl chloride, fluorocarbon iodides (for example, CF₂I₂, CF₃I, I—(CF₂)₄—I, (CF₃)₂CFI and the like), etc.

The emulsion polymerization conditions of the present invention are optionally selected depending on kind and components of the intended fluorine-containing polymer and kind of a polymerization initiator. A reaction temperature is usually from −20° C. to 150° C., preferably from 5° C. to 100° C., and a polymerization pressure is not more than 10 MPaG, preferably not more than 5 MPaG.

In the preparation of the fluorine-containing polymer of the present invention, a method of introducing each component (particularly monomer, initiator and chain transfer agent) in a polymerization tank is not limited particularly. There may be used a method of firstly introducing a total amount of each component to be used or a method of introducing a part or the whole of components continuously or dividedly into a polymerization tank.

The fluorine-containing polymer latex obtained in the present invention is a latex (aqueous emulsion) containing about 10% by weight to about 40% by weight, preferably from 20% by weight to 40% by weight of fluorine-containing polymer particles having a number average molecular weight of from about 0.01 μm to about 1 μm, preferably from 0.01 to 0.7 μm, and a dispersing and emulsifying state of particles is stable.

In the case of FEP, a content of FEP in polymer particles is higher in the FEP latex obtained by the preparation process of the present invention than in FEP latex obtained by using ammonium perfluorooctanoate which is a conventional general-purpose emulsifying agent.

For coagulation and agglomeration, known methods can be used as they are. For example, there can be preferably employed a method of adding a coagulant (agglomerating agent) to a latex with stirring and then coagulating (agglomerating), a method of freezing and then thawing a latex to coagulate it (freeze-coagulation method), a method of coagulating only by mechanically stirring a latex at high speed (mechanical coagulation method), a method of spraying a latex through a thin nozzle and at the same time, evaporating water (spray coagulation method) and the like method. As case demands, a coagulant aid may be added. A coagulated product may be dried by allowing to stay at room temperature or by heating up to 250° C.

The present invention also relates to an aqueous dispersion of fluorine-containing polymer, so-called dispersion obtained by subjecting the fluorine-containing polymer latex obtained by the preparation process of the present invention to concentration or dispersion stabilizing treatment.

For the concentration, known methods can be employed and the latex is concentrated to 40 to 60% by weight depending on applications (for example, aqueous dispersion type coatings, binding agent for electrode, water repelling agent for electrode, etc.). Though there is a case where stability of the dispersion is lowered by the concentration, in that case, a dispersion stabilizing agent may be added. As such a dispersion stabilizing agent, the above-mentioned surfactants used in the present invention or other various surfactants may be added. Non-limiting examples of preferred dispersion stabilizing agent are nonionic surfactants such as polyoxyalkylether, particularly polyoxyethylene ethers such as polyoxyethylene alkylphenyl ether (for example, TRITON X-100 (trade name) available from Union Carbide Co., Ltd.), polyoxyethylene isotridecyl ether (DISPANOL TOC (trade name) available from NOF Corporation) and polyoxyethylene propyltridecyl ether.

Also an aqueous dispersion of fluorine-containing polymer having a long pot life can be prepared by the dispersion stabilizing treatment without concentration, depending on applications. Examples of the dispersion stabilizing agent are the same as above.

The latex, powder and aqueous dispersion obtained by the preparation process of the present invention are useful as a coating and molding material for which fluorine-containing materials have been used and in addition, as a filter material, film material, lining material, tube material, etc., and also are useful as materials for a gasket, packing, filter membrane, bearing material, covering material for cable, binding agent for electrode, water repelling agent, impregnant for glass cloth, fuel hose, vibration-proof rubber and the like. The application thereof is not limited to them.

The present invention is then explained by means of examples, but is not limited to them.

Firstly, methods of measuring MFR value and an amount of HFP in FEP particles which are prescribed in the present invention are explained below.

(a) MFR Value

KAYNESS melt index tester model 4002 is used. According to ASTM-D-1238/JIS-K-7210, about 6 g of resin is poured in a 0.376 inch ID cylinder which is maintained at 372° C.±0.5° C., followed by allowing to stand. After five minutes, when the temperature of the resin reached an equilibrium state, the resin is extruded at a piston load of 5,000 g through an orifice having a diameter of 0.0825 inch and a length of 0.315 inch. An average of MFR values measured three times at nearly the same time is used as the MFR value in g/10 min.

(b) Amount of HFP

An amount of HFP is calculated from a value measured by using a NMR analyzer.

### EXAMPLE 1

A 50-liter horizontal stainless steel autoclave equipped with a stirrer was previously evacuated and then was charged with 30 kg of deaerated distilled water and 5 kg of an aqueous dispersion of 10% by weight of fluorine-containing surfactant (F(CF₂)₅—O—CF(CF₃)COONH₄) (concentration of surfactant: 1.6% by weight). Further thereto were added 5 kg of HFP monomer (liquid) and then a gaseous TFE/HFP monomer mixture (TFE:HFP=89.2:9.8 (% by weight)), followed by gradually heating to 95° C. with stirring. The inside pressure of the autoclave was increased to 1.5 MPaG at 95° C. Then 3.5 kg of an aqueous solution of ammonium persulfate (10% by weight) as an initiator was introduced to initiate reaction. A gaseous TFE/HFP monomer mixture having the same proportion as above was supplied continuously to maintain the pressure of 1.5 MPaG. Forty minutes after, the stirring was stopped and un-reacted TFE and HFP monomers were collected to obtain 30.5 kg of FEP dispersion having a solid polymer content of 4.8% by weight. This dispersion is called FEP dispersion containing FEP seed particles.

A part of the FEP dispersion was coagulated with nitric acid to obtain a white powder. The obtained FEP was one comprising TFE:HFP=89.5:10.5 (mole ratio), and MFR could not be measured. An amount of HFP of the FEP was 15.3% by weight.

Then the autoclave used above was previously evacuated, and was charged with 30 kg of deaerated distilled water and 1 kg of FEP dispersion containing FEP seed particles obtained above (concentration of surfactant: 550 ppm). Further the autoclave was charged with 18.1 kg of HFP monomer (liquid) and then a gaseous TFE/HFP monomer mixture (TFE:HFP=90.2:9.8 (mole ratio)), followed by gradually heating to 95° C. with stirring. The inside pressure of the autoclave was increased to 4.2 MPaG at 95° C.

Then 0.1 kg of an aqueous solution of ammonium persulfate (10% by weight) was introduced to initiate reaction. Immediately after stating of the reaction, an aqueous solution of ammonium persulfate (10% by weight) was continuously introduced at 1.1 g/min till completion of the reaction. Also after starting of the reaction, a gaseous TFE/HFP monomer mixture having the same proportion as above was supplied continuously so that the pressure of a reaction system can be maintained at 4.2 MPaG. Polymerization was continued until a solid polymer content reached 20% by weight. A reaction time was 62 minutes. Then un-reacted TFE and HFP monomers were collected and a latex was removed.

The FEP latex was coagulated with nitric acid to obtain a white powder. An amount of FEP after drying was about 8.0 kg.

A ratio (mole ratio) of TFE:HFP of the obtained FEP was 89.2:9.8, and MFR was 19.1 g/10 min. A proportion of HFP in FEP was 13.7% by weight.

### COMPARATIVE EXAMPLE 1

The same autoclave as in Example 1 was previously evacuated and then was charged with 30 kg of deaerated distilled water and 5 kg of an aqueous dispersion of 10% by weight of ammonium perfluorooctanoate (C₇F₁₅COONH₄) as a fluorine-containing surfactant (concentration of surfactant: 1.6% by weight). Further thereto were added 5 kg of HFP monomer (liquid) and then a gaseous TFE/HFP monomer mixture (TFE:HFP=91.2:9.8 (% by mole)), followed by gradually heating to 95° C. with stirring. The inside pressure of the autoclave was increased to 1.5 MPaG at 95° C. Then 3.5 kg of an aqueous solution of ammonium persulfate (10% by weight) as an initiator was introduced to initiate reaction. A gaseous TFE/HFP monomer mixture having the same proportion as above was supplied continuously to maintain the pressure of 1.5 MPaG. Thirty minutes after, the stirring was stopped and un-reacted TFE and HFP monomers were collected to obtain 31.4 kg of FEP dispersion having a solid polymer content of 4.5% by weight.

A part of the dispersion was coagulated with nitric acid to obtain a white powder. The obtained FEP was one comprising TFE:HFP=89.9:10.1 (mole ratio), and MFR could not be measured. An amount of HFP of the FEP was 14.5% by weight.

Then the autoclave used above was previously evacuated, and was charged with 30 kg of deaerated distilled water and 1 kg of FEP dispersion containing FEP seed particles obtained above (concentration of surfactant: 550 ppm). Further the autoclave was charged with 18.1 kg of HFP monomer (liquid) and then a gaseous TFE/HFP monomer mixture (TFE:HFP=91.2:9.8 (mole ratio)), followed by gradually heating to 95° C. with stirring. The inside pressure of the autoclave was increased to 4.2 MPaG at 95° C.

Then 0.1 kg of an aqueous solution of ammonium persulfate (10% by weight) was introduced to initiate reaction. Immediately after stating of the reaction, an aqueous solution of ammonium persulfate (10% by weight) was continuously introduced at 1.1 g/min till completion of the reaction. Also after starting of the reaction, a gaseous TFE/HFP monomer mixture having the same proportion as above was supplied continuously so that the pressure of a reaction system can be maintained at 4.2 MPaG. Polymerization was continued until a solid polymer content reached 20% by weight. A reaction time was 60 minutes.

Then un-reacted TFE and HFP monomers were collected and a latex was removed.

The FEP latex was coagulated with nitric acid to obtain a white powder. An amount of FEP after drying was about 7.5 kg.

A ratio (mole ratio) of TFE:HFP of the obtained FEP was 90.3:9.7, and MFR was 18.4 g/10 min. A proportion of HFP in FEP was 13.2% by weight.

### EXAMPLE 2

A FEP dispersion containing FEP seed particles was prepared in the same manner as in Example 1, and then the autoclave was previously evacuated, and was charged with 30 kg of deaerated distilled water and 1 kg of the FEP dispersion. Further the autoclave was charged with 6.9 kg of HFP monomer (liquid), 0.2 kg of perfluoropropylvinylether and a gaseous TFE/HFP monomer mixture (TFE:HFP=91.6:8.4 (mole ratio)), followed by gradually heating to 95° C. with stirring. The inside pressure of the autoclave was increased to 4.2 MPaG at 95° C.

The same procedures as in Example 1 were carried out from starting of the reaction to stopping of the reaction except that an initially charged amount of the polymerization initiator was 80 g, a continuously introduced amount of the polymerization initiator was 0.9 g/min and 20 g of perfluoropropylvinylether was added at the time when a solid polymer content during the reaction reached 5% by weight, 10% by weight and 15% by weight, respectively so that the proportion of produced FEP became constant. After 50-minute polymerization, un-reacted TFE, HFP and perfluoropropylvinylether were collected and a latex was removed.

The FEP latex was coagulated with nitric acid to obtain a white powder. An amount of FEP after drying was about 8.0 kg.

A ratio (mole ratio) of TFE:HFP:perfluoropropylvinylether of the obtained FEP was 91.9:7.7:0.4, and MFR was 24.3 g/10 min. A proportion of HFP in FEP was 12.0% by weight.

### COMPARATIVE EXAMPLE 2

A FEP dispersion containing FEP seed particles was prepared by using ammonium perfluorooctanoate in the same manner as in Comparative Example 1, and then the autoclave was previously evacuated, and was charged with 30 kg of deaerated distilled water and 1 kg of the FEP dispersion. Further the autoclave was charged with 6.9 kg of HFP monomer (liquid), 0.2 kg of perfluoropropylvinylether and a gaseous TFE/HFP monomer mixture (TFE:HFP=91.6:8.4 (mole ratio)), followed by gradually heating to 95° C. with stirring. The inside pressure of the autoclave was increased to 4.2 MPaG at 95° C.

The same procedures as in Example 1 were carried out from starting of the reaction to stopping of the reaction except that an initially charged amount of the polymerization initiator was 80 g, a continuously introduced amount of the polymerization initiator was 0.9 g/min and 20 g of perfluoropropylvinylether was added at the time when a solid polymer content during the reaction reached 5% by weight, 10% by weight and 15% by weight, respectively so that the proportion of produced FEP became constant. After 50-minute polymerization, un-reacted TFE, HFP and perfluoropropylvinylether were collected and a latex was removed.

The FEP latex was coagulated with nitric acid to obtain a white powder. An amount of FEP after drying was about 7.7 kg.

A mole ratio of TFE:HFP:perfluoropropylvinylether of the obtained FEP was 91.5:8.1:0.4, and MFR was 23.5 g/10 min. A proportion of HFP in FEP was 11.5% by weight.

According to the preparation process of the present invention, a latex containing FEP particles particularly having a high content of HFP as compared with the case where a conventional general-purpose fluorine-containing surfactant such as ammonium perfluorooctanoate is used can be obtained.

1. A process for preparing a fluorine-containing polymer latex which comprises emulsion-polymerizing a fluorine-containing olefin solely or a fluorine-containing olefin and other monomer in an aqueous medium in the presence of at least one of fluorine-containing surfactants represented by the formula (I):
F(CF₂ₘO—(CF(X)CF₂—OₙCF(X)COOM
wherein X is fluorine atom or a linear or branched lower perfluoroalkyl group; —COOM is a carboxylic acid salt; m is an integer of from 3 to 10; n is 0, 1 or 2.

2. The preparation process of claim 1, wherein said carboxylic acid salt represented by —COOM is an alkali metal salt, ammonium salt or lower alkylamine salt.

3. The preparation process of claim 1, wherein said fluorine-containing olefin is tetrafluoroethylene, hexafluoropropylene and/or perfluoro(alkyl vinyl ether), and an obtained fluorine-containing polymer is a tetrafluoroethylene copolymer.

4. The preparation process of claim 3, wherein the emulsion-polymerization is initiated by adding at least one of the fluorine-containing surfactants of claim 1 in an amount of from 0.001 to 5.0% by weight based on the aqueous medium at initiating the polymerization.

5. The preparation process of claim 1, wherein said fluorine-containing olefin is a monomer mixture of two or more of vinylidene fluoride, tetrafluoroethylene, hexafluoropropylene, chlorotrifluoroethylene and perfluoro(alkyl vinyl ether), and an obtained fluorine-containing copolymer is a fluoro elastomer.

6. The preparation process of claim 5, wherein the emulsion-polymerization is initiated by adding at least one of the fluorine-containing surfactants of claim 1 in an amount of from 0.001 to 20.0% by weight based on the aqueous medium at initiating the polymerization.

7. The preparation process of claim 1, wherein said fluorine-containing olefin is tetrafluoroethylene, and an obtained fluorine-containing polymer is polytetrafluoroethylene.

8. The preparation process of claim 7, wherein the emulsion-polymerization is initiated by adding at least one of the fluorine-containing surfactants of claim 1 in an amount of from 0.001 to 0.5% by weight based on the aqueous medium at initiating the polymerization.

9. A fluorine-containing polymer powder obtained by coagulating or agglomerating fluorine-containing polymer particles from a fluorine-containing polymer latex obtained by the preparation process of claim 1.

10. An aqueous dispersion of fluorine-containing polymer obtained by subjecting the fluorine-containing polymer latex obtained by the preparation process of claim 1 to concentrating or dispersion stabilizing treatment.
